(19) United States
(12) Patent Application Publication
(10) Pub. No.: US 2016/0334493 A1
(43) Pub. Date: Nov. 17, 2016

(54) USING LORAN FOR TERRESTRIAL TIME TRANSFER

(71) Applicant: iPosi, Inc., DENVER, CO (US)

(72) Inventors: RICHARD M. LEE, DENVER, CO (US); ERIC DERBEZ, Vancouver (CA)

(21) Appl. No.: 15/130,290

(22) Filed: Apr. 15, 2016

Related U.S. Application Data
(60) Provisional application No. 62/148,538, filed on Apr. 16, 2015.

(51) Int. Cl. G01S 1/24; G01S 19/04

(52) U.S. Cl. CPC G01S 1/245; G01S 19/04

(57) ABSTRACT

Techniques for allowing a remote receiver (such as a small cell) to derive a precise time reference (such as Coordinated Universal Time (UTC)) when the remote receiver is not able to derive time directly from received GPS signals. The remote receiver receives LORAN signals from a LORAN station and determines the propagation time from the LORAN station to the remote receiver. The remote receiver derives a precise time reference from the received LORAN signals and the propagation time. The remote receiver may receive additional timing information from a reference station.

### CROSS REFERENCE TO RELATED APPLICATIONS

This application claims priority to U.S. Provisional Application No. 62/148,538, filed on Apr. 16, 2015, and entitled “USING LORAN FOR TERRESTRIAL TIME TRANSFER,” the entirety of which is incorporated by reference herein.

### GLOSSARY

AWGN additive white Gaussian noise

ASF additional secondary factor

APF ancillary primary factor

alpha filter roll off factor

BCCH broadcast control channel

C carrier power

CCCH common control channel

CI coherent integration

dB decibel

E911 Enhanced 911

E_{b} Energy per bit

E_{c} Energy per chip

Eₛ energy per symbol

EIRP effective isotropic radiated power

FCC Federal Communications Commission

GHZ gigahertz

GNSS global navigation by satellite system

GPS Global Position System

KHz kilohertz

Km kilometer

LORAN Long Range Navigation

LTE Long Term Evolution

MHz megahertz

m meter

ms milliseconds

N₀ noise power spectral density

NCI non coherent integration

ns nanosecond

OCXO oven-controlled crystal oscillator

OFDM orthogonal frequency division multiplexing

OFDMA orthogonal frequency division multiple access

Pᵣ received power

ppb parts per billion

PF primary phase factor

RF radio frequency

RRC root raised cosine

Rx receive

SF secondary phase factor

SNR signal to noise ratio

spc samples per chip

sps samples per symbol

Tx transmit

VLF very low frequency

### BACKGROUND

This disclosure addresses commercial metrology back-ups to GNSS so as to provide accurate time and frequency data for GNSS signal processing even in the absence of or corruption of timing and frequency data obtained from GNSS itself. Additionally, the present disclosure includes techniques for assisting GNSS in initial time and frequency discipline. Throughout this disclosure the generic term GNSS, the specific term GPS, or the combination

GPS/GNSS may be used and such references shall refer to any such navigational system, including, but not limited to, GPS, GLONASS (Russian), Galileo (European), Indian Regional Navigation Satellite System (IRNSS), BeiDou-2 (Chinese), or other such comparable navigation system.

GPS receivers in high security or high sensitivity applications may benefit from an accurate time and/or frequency reference. For instance, time and/or frequency data may be used to discipline a local clock or oscillator of a receiver to a common time and/or frequency reference. The accuracy of the local clock and/or oscillator may affect the accuracy of a determined location at the GPS receiver. As such, providing an accurate local clock and/or oscillator may be of great importance or signal acquisition and/or other processing (such as integration of signals).

GPS receivers in high security or high sensitivity applications may be threatened by intentional and non-intentional jammers that disrupt GNSS reception, or intentional “spoofers” that attempt to capture and transfer false timing signals that corrupt the time and location presented to the host equipment. If these attacks are sustained for more than about two hours, the only relief is through interim “fallback” to another radio timing solution.

Currently this problem is solved by using Rubidium clocks, or for cases with very short holdover requirements, by using high-grade OCXOs. However, such approaches include use of expensive hardware that add to the cost and complexity of receivers.

It is against this background that the techniques described herein have been developed.

### SUMMARY

Disclosed herein is a method for deriving a precise time and/or frequency reference when GNSS signals are not directly available. The method includes determining that GNSS signals are not directly available; receiving LORAN signals from a LORAN station; determining the propagation time for the LORAN signals; and deriving a precise time reference from the received LORAN signals from LORAN station and the propagation time.

Also disclosed is a method for deriving a precise time and/or frequency reference when another precise time and/or frequency reference is not available. The method includes receiving LORAN signals from a LORAN station and determining the propagation time for the LORAN signals. The method also includes deriving a precise time reference from the received LORAN signals received from LORAN station and the propagation time when the another precise time reference is not available.

Also disclosed is a method for deriving a precise time and/or frequency reference when GNSS signals are not directly available. The method includes determining that GNSS signals are not directly available; receiving a plurality of LORAN signals from a LORAN station; receiving precise timing information from a reference station, the precise timing information including time tags for each received signal from the LORAN station, the time tag including a precise time reference for the time that the LORAN station sent the respective signal; and deriving a precise time reference from the received LORAN signals received from LORAN station and the time tags received from the reference station corresponding to the received LORAN signals. For instance, this method may be performed by a GNSS receiver to maintain accuracy of a local clock and/or oscillator relative to a GNSS time paradigm even in the absence of the ability to acquire GNSS signals. Notably, given the time discipline is provided via received LORAN signals, the need for a highly expensive oscillator may be reduced.

Multiple LORAN signals may be received from the LORAN station within a two-second period. In turn, the deriving may include integrating over the multiple received LORAN signals to improve the signal-to-noise ratio of the received LORAN signal to improve accuracy of any time and/or frequency reference derived from the LORAN signal. The time tags may be adjusted for latency between the reference station and the receiving of the time tags.

Also disclosed is a method for deriving a precise time and/or frequency reference when another precise time and/or frequency reference is not available. The method includes receiving LORAN signals from a LORAN station and receiving precise timing information from a reference station. The method may also include deriving a precise time reference from the received LORAN signals received from LORAN station and the precise timing information received from the reference station when the another precise time reference is not available.

The precise timing information received from the reference station may include time tags for each received signal from the LORAN station, the time tag including a precise time reference for the time that the LORAN station sent the respective signal. The another precise time reference may be GNSS time. For instance, the another precise time reference may be GPS time. The method may further include correlating the new polluted signal to a previously known multi-path polluted LORAN correlation pattern to effect a sub-microsecond accuracy when dealing with heavily-attenuated LORAN signals in the scenario of a failover from GNSS

Also disclosed is a system for deriving a precise time and/or frequency reference with the aid of LORAN signals from a LORAN station. The system includes a reference station located within range of the LORAN signals from the LORAN station, the reference station receiving GNSS signals and determining a precise time and/or frequency reference therefrom, the reference station also receiving LORAN signals from the LORAN station and determining the time of transmission of one or more of the LORAN signals from the LORAN station based at least in part on the distance between the LORAN station and the reference station; and a receiver also located within range of the LORAN signals from the LORAN station, the receiver being in communication with the reference station to receive from the reference station the time of transmission of the one or more LORAN signals, wherein the receiver derives a precise time and/or frequency reference based at least in part on the received LORAN signals and their time of transmission from the LORAN station.

The derivation by the receiver may also be based on the distance between the LORAN station and the receiver.

Also disclosed is a method for providing timing information (e.g., including phase and/or frequency information) to a remote receiver, in part by utilizing LORAN signals from a LORAN station. The method includes receiving GNSS signals at a reference station; determining a precise time reference from the GNSS signals; receiving LORAN signals from a LORAN station; determining the time of transmission of one or more LORAN signals from the LORAN station based at least in part on the distance between the LORAN station and the reference station; and communicating the time of transmission of the one or more LORAN signals to a remote receiver.

### BRIEF DESCRIPTION OF THE DRAWINGS

FIG. 1 is a high level diagram of use of the techniques disclosed herein to allow a device to derive a precise time reference.

FIG. 2a is an illustration of the integration/summation of LORAN pulses and FIG. 2b is a graph of SNR increasing (improving) with further integration.

FIG. 3 is a graph of interference sources affecting LORAN signals.

FIG. 4 is a map view diagram of four reference stations and their positions relative to a pair of LORAN stations, and three fielded receivers.

FIG. 5 is a flowchart of certain techniques disclosed herein.

### DETAILED DESCRIPTION

While the disclosure is susceptible to various modifications and alternative forms, specific embodiments thereof have been shown by way of example in the drawings and are herein described in detail. It should be understood, however, that it is not intended to limit the disclosure to the particular form disclosed, but rather, the disclosure is to cover all modifications, equivalents, and alternatives falling within the scope as defined by the claims.

Disclosed herein are techniques for using the VLF signals of the LORAN system (a Long Range Navigation system installed by the US government during World War II) as a diverse alternative timing solution in the event of GPS signal outages due to jamming or other interventions (such as cable cuts to antenna feeds, etc.). LORAN systems are extensive throughout the US and worldwide as navigational tools. This method addresses transfer of both time and frequency references useful to provide long term integration of signals using advanced digital signal processing and IP Network assistance methods.

VLF LORAN stations provide distinct identification data that identify the LORAN radio station from which the transmission originates. Each LORAN radio station is located at a known point with precise geo-coordinates. With this information (which may be known a priori and, for example, stored in a database accessible by a processor of a receiver), time can be precisely determined in the event of sustained GPS/GNSS outage in order to avoid cumbersome, high maintenance, and expensive alternative forms of holdover, including either atomic Cesium or Rubidium clocks. As may be appreciated, use of such atomic clocks may be cost prohibitive in relation to GPS receivers.

One issue is that of reliably detecting LORAN signals in indoor urban settings and using these signals to provide indefinite holdover to a previously GNSS-disciplined oscillator. A problem related to aiding GNSS acquisition is similar to acquisition of highly attenuated LORAN signals. Namely, the issue is how to acquire a LORAN signal with some rough a priori knowledge of receiver location so as to provide a good enough time and position to the GNSS receiver. One embodiment of the techniques disclosed herein includes having an indoor assisted receiver with antennas capable of jointly or separately receiving LORAN and GNSS signals.

The GNSS signals are processed via the methods described by U.S. Pat. No. 7,961,717 (henceforth “the '717 Patent”) or some similar manner which enables their acquisition. The entire contents of the '717 Patent are hereby incorporated by reference into this disclosure. The GNSS receiver is then assumed to have obtained an accurate position and to have GNSS grade time accuracy of within +/− of about 100's of nanoseconds. The GNSS receiver could have done so using the assistance methods described in the '717 Patent.

This disclosure also deals with an assisted receiver design to detect heavily attenuated LORAN signals (e.g. inside urban buildings) by using the time and frequency derived from GNSS to acquire the LORAN signal from a pre-determined LORAN station with pre-determined SF and ASF corrections while also using LORAN reference station data. By using the LORAN signal, time, and frequency, the receiver can be back-up in a seamless fashion should GNSS signals not be received. PF allows for compensation based on the fact that the speed of the propagated signal in the atmosphere is slightly lower than in a vacuum. SF allows for compensation for the fact that the speed of propagation of the signal is slowed when traveling over seawater because of the greater conductivity of seawater compared to land. ASF allows for compensation for the fact that, because LORAN-C transmitters are mainly land based, the signal will travel partly over land and partly over seawater. ASF may be treated as land and water segments, each with a uniform conductivity depending on whether the path is over land or water.

Another aspect of this system is that it can use LORAN signal information to assist GNSS acquisition. Once the receiver has locked onto a LORAN signal, and then the a priori user position, the a priori APFs on the LORAN signal (used to compensate for terrain-induced path delays) can be used to derive approximate fine-time to initiate the GNSS search for initial acquisition. In this mode, the LORAN signal replaces the time and frequency supplied by PTP as described in the '717 Patent.

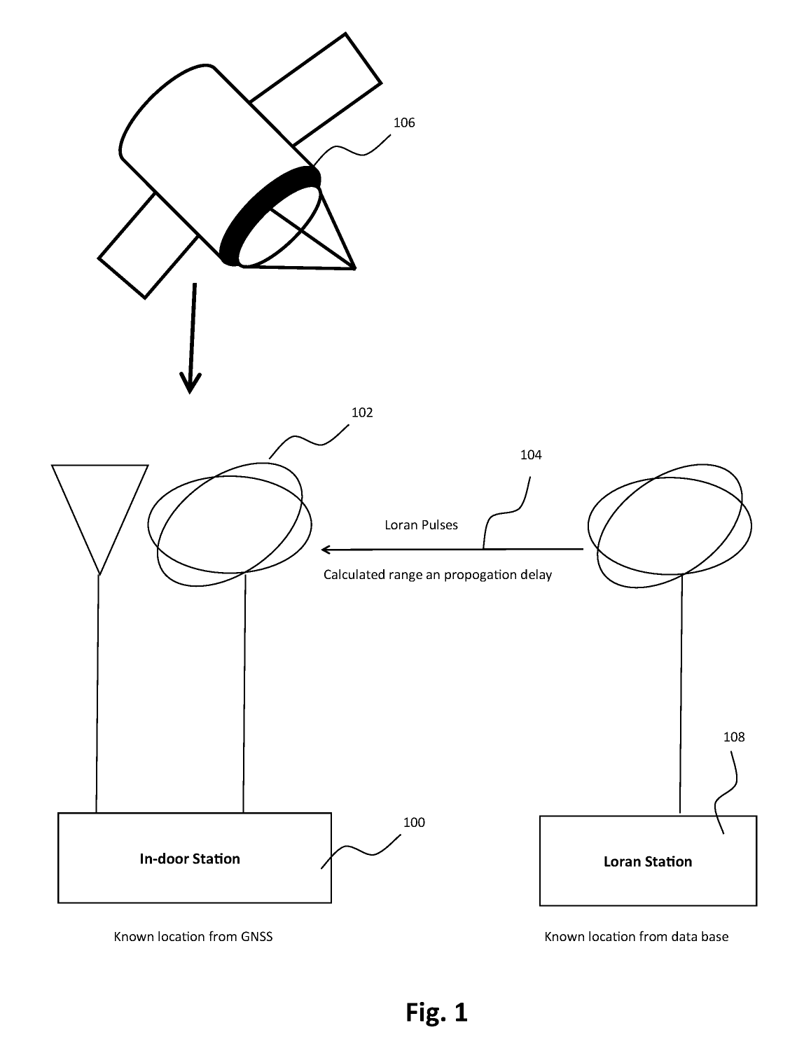

With reference to FIG. 1 a GNSS receiver 100 may be equipped with two H-field loop antennas 102 mounted perpendicular to each other, as shown in FIG. 1. The steps below describe how LORAN signals 104 from a LORAN station 108 can be used to back-up GNSS time and frequency derived from a GNSS space vehicle 106.

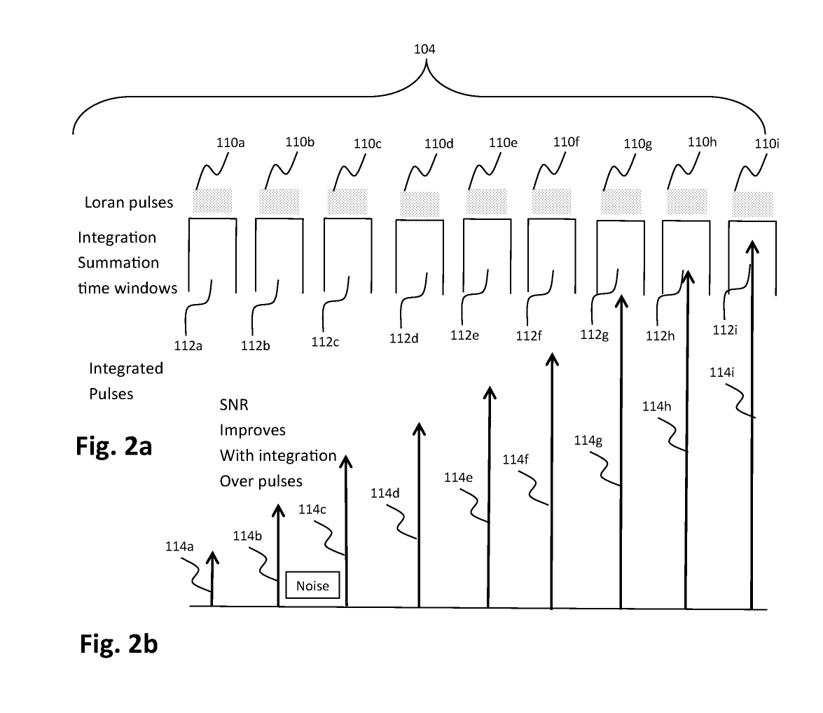

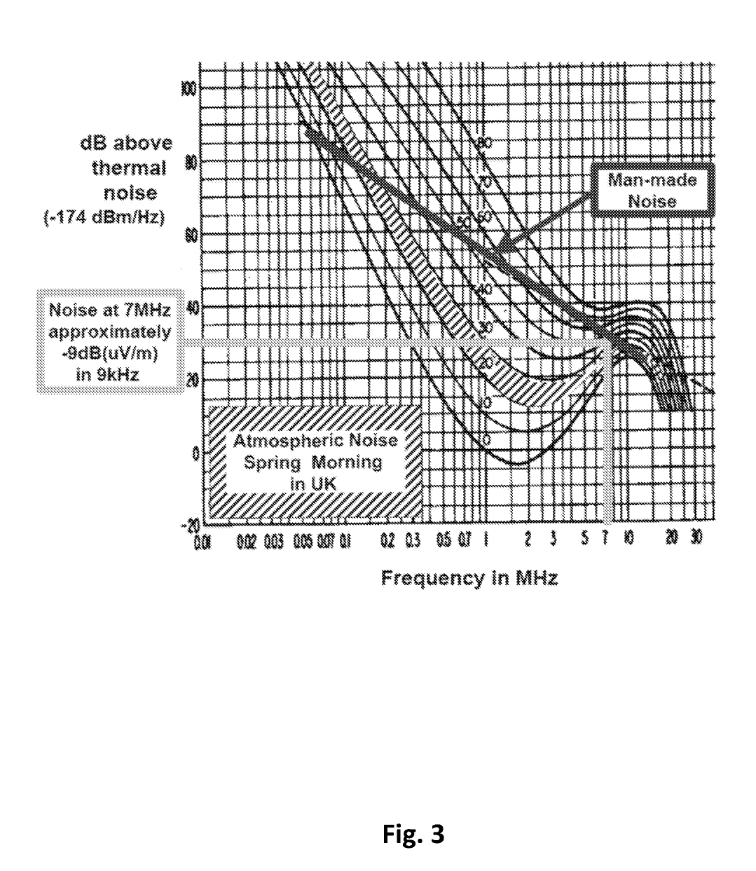

On an opportunistic or scheduled basis, the receiver 102 attempts to detect the LORAN wave pulses 104 by taking into account the known transmit times and distances between the receiver 102 and the nearest LORAN station(s) 108. A diagrammatic view of the LORAN wave pulses 104 are shown in FIG. 2. The LORAN stations 108 each transmit 8 or 9 bursts 110, each burst 110 separated by 1 millisecond. The Master in a given chain will transmit 9 bursts 110; the slaves will transmit 8 bursts 110. Each burst 110 has one of two polarities modulated by the carrier envelope (the carrier frequency being 100 KHz). The bursts from master and slaves have a Group Repetition Interval of 40 to 100 ms. The 8 to 9 bursts 110 from a station can be coherently integrated in corresponding integration summation time windows 112 by knowing a priori the polarities coded onto the carrier (by means of aiding reference stations which read and time-tag this data). By estimating the building losses incurred by GNSS signals in roughly the same direction as the chosen LORAN station 108, and by coherently integrating the signals only within a corresponding window 112 which encompasses a priori APF and ASF delays relative to the station 108, the receiver 102 can build up enough signal strength 114 to detect the signal 104. By integrating only over those time windows 112, the receiver 102 can avoid integrating over many noise sources which are known not to contain any LORAN bursts 110 (since accurate time and distance to LORAN stations 108 can be deduced via GNSS), as seen in FIG. 1. FIG. 2 illustrates the integration time windows 112 and FIG. 3 describes the major interference sources for LORAN: lightning ground-return strikes (outdoors), and impulsive motor or lighting sources (indoors).

Note that the LORAN data modulated in the bursts 110 is known, and can be time-tagged and shared with the receiver 102 via assistance techniques described in the '717 Patent for coherent integration. In principle, so long as the receiver clock is disciplined by a stable reference such as GNSS, the coherent integration can be performed for arbitrarily long periods. For an undisciplined receiver oscillator, one can coherently integrate up to the stability limits of the local oscillator and then perform non-coherent integration of the LORAN signal(s). Knowing the attenuation of GNSS signals in the directions of the LORAN stations (as described above) will give an a priori indication of the number of coherent sums necessary to detect the LORAN signal(s).

Once detected, the actual LORAN offset with respect to GNSS time can be recorded for holdover requirements. Note that the offset between LORAN time and GNSS time may change by more than 50 ns due to seasonal variations of ASFs (e.g. snow on the ground, etc.). These require periodic re-calibrations of the LORAN to GNSS offset for optimal holdover performance.

In a holdover scenario, the local receiver oscillator will be within a few ppb (parts per billion) of the receiver oscillator's nominal frequency and will have GNSS time to within a few hundred nanoseconds. If GNSS lock is lost for whatever reason, the receiver 102 can then revert to tracking LORAN since the receiver 102 will know (within a few hundred nanoseconds) when to expect the next LORAN bursts 110, and when to blank-out the rest of the noise on the LORAN channel as well as what data is modulated on the signal (via a reference station). The receiver 102 may also know (historically) how many coherent sums it will take to build up enough SNR to declare detection.

Note also that there may be cases in which the LORAN signal 104 can be tracked with integration periods 112 much shorter than those needed for GNSS tracking. In those cases, the LORAN signal may be used to lock (or periodically correct) the receiver's local oscillator—thereby allowing the GNSS receiver to perform a greater number of NCIs than its local oscillator would have otherwise allowed. Thus, LORAN as a frequency source can, in some instances, help increase the sensitivity of GNSS.

Conversely, if LORAN is used to help GNSS acquisition in the absence of network aiding, as per the '717 Patent, then it may be advantageous to use multiple frequency hypotheses, as well as timing hypotheses, given the absence of fine-time aiding. Also, because of the absence of time aiding for the modulated data, non-coherent integration of the signal must be employed, which will require longer integration time to build up the SNR necessary to detect the LORAN signal. This non-coherent detection gives rise to the further problem of disambiguating the source of the signal. Specifically, once signal detection has been declared, then further coherent integration techniques may be applied, hypothesizing each of the candidate stations 108 in the chain to determine which station 108 is being tracked. Finally, a reasonable a priori knowledge of the position of the receiver 102 as well as the APF (ancillary primary effects) may be needed to complete the approximate transfer of LORAN time to the receiver 102. Note that once the detection of the signal is successful, one can then lock the receiver's oscillator to the LORAN signal 104.

It should be understood that the techniques disclosed herein could apply to situations where a device 102 receives LORAN signals and derives time therefrom as well as other situations where a LORAN reference station that receives LORAN signals and is also receptive of GNSS signals is able to time tag the LORAN signals and provide time reference information to a fielded receiver 102. The term “fielded receiver” is used herein to designate a device which may or may not be portable (e.g., a smart phone), may be indoors or outdoors, and may or may not be in a position where it can receive GNSS signals.

In summary, it can be appreciated that (a) LORAN can be used to acquire and start using GNSS time (e.g., LORAN can provide coarse time), (b) once GNSS time is being used, LORAN can provide a fallback/holdover if GNSS is lost, and (c) GNSS can be used to aid in LORAN signal acquisition (e.g., by knowing GNSS time and position as well as burst pair timing information). Below is a summary of some of the desirable features of the techniques discussed herein:
1. Using GNSS to aid in the acquisition of LORAN by knowing the a fortiori attenuation of GNSS signals to determine the a priori integration length for LORAN acquisition.
2. Searching/integrating over the known LORAN signal pulses using the GNSS derived time to bracket the search time.
3. Providing fine-time and frequency assistance for the acquisition of LORAN signals from GNSS and the calculated GNSS position of the GNSS/LORAN receiver and the known distance and propagation time from the LORAN transmitters to the GNSS/LORAN receiver.
4. Using LORAN to back-up GNSS receivers for time and frequency after the GNSS/LORAN receiver detects LORAN signals and compensates for the propagation time from the LORAN transmitters to the GNSS/LORAN receiver.
5. Autonomously acquiring heavily-attenuated LORAN signals via assistance from reference stations.
6. Using LORAN derived frequency to steer the GNSS reference oscillator to a stable frequency eliminating GNSS oscillator errors and hence improve its sensitivity.
7. Using LORAN derived time to limit the search range for GNSS and hence improve its sensitivity.
8. Correlating the new polluted signal to a previously known multi-path polluted LORAN correlation pattern to effect a sub-microsecond accuracy when dealing with heavily-attenuated LORAN signals in the scenario of a failover from GNSS.

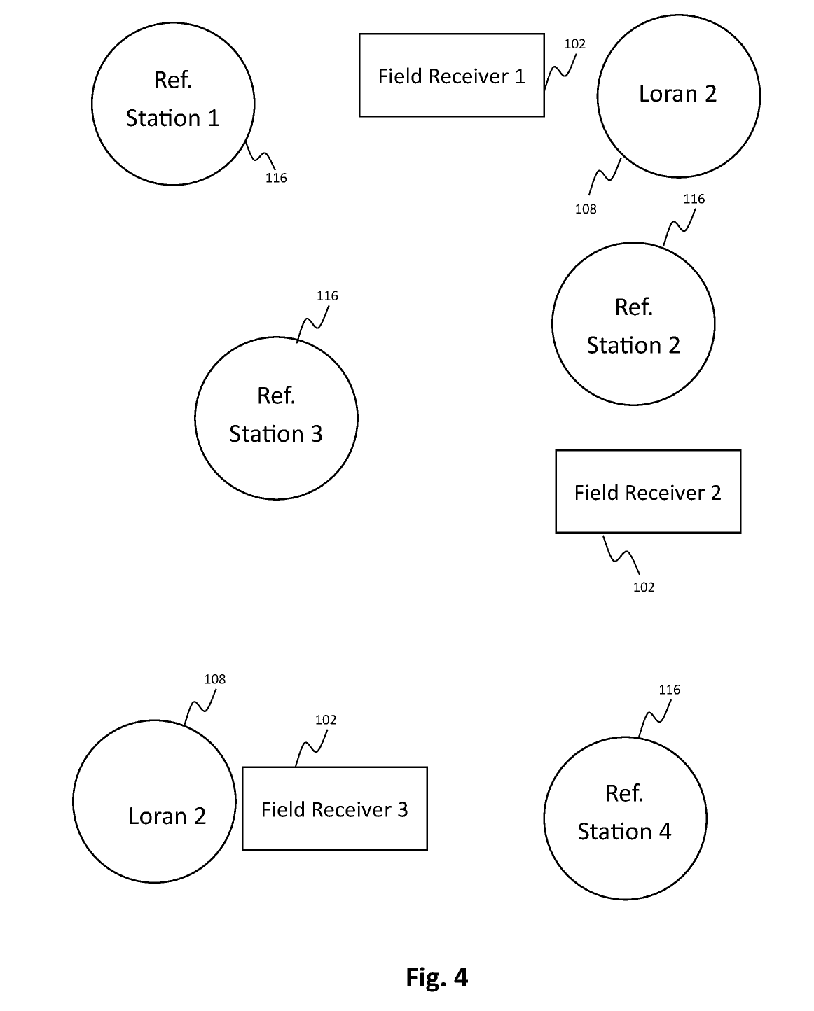

FIG. 4 is a map view diagram of four reference stations 116 (Ref. Stations 1-4) and their positions relative to a pair of LORAN stations 108 (LORAN 1 and 2), as well as three fielded receivers 102 (Fielded Receivers 1-3).

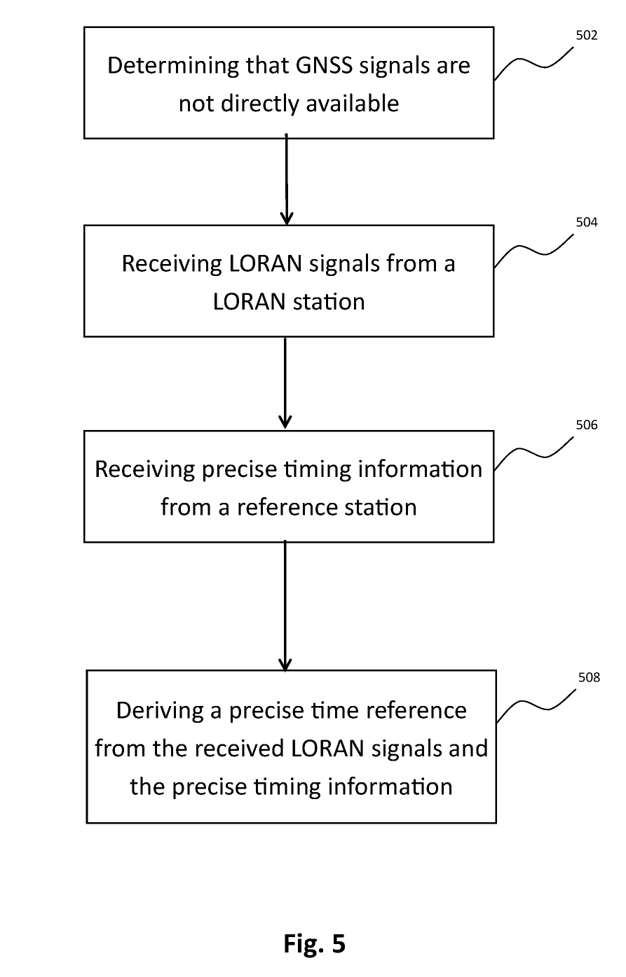

FIG. 5 is a flowchart showing a method 500 for deriving a precise time reference when GNSS signals are not directly available. The method includes determining 502 that GNSS signals are not directly available; receiving 504 LORAN signals from a LORAN station; receiving 506 precise timing information from a reference station; and deriving 508 a precise time reference from the received LORAN signals and the precise timing information.

This disclosure incorporates by reference in its entirety the disclosure in U.S. patent application Ser. No. 15/061,808, filed on Mar. 4, 2016, entitled “Using DME for Terrestrial Time Transfer.” To the extent the DME beacon signals in that disclosure are replaced with LORAN signals, the teachings therein are all applicable here.

While the foregoing has illustrated and described several embodiments in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the disclosure are desired to be protected.

What is claimed is:

1. A method for deriving a precise time reference at a receiver when GNSS signals are not directly available at the receiver, comprising:
determining that GNSS signals are not directly available for acquisition at the receiver;
receiving LORAN signals from a LORAN station at the receiver;
determining the propagation time for the LORAN signals traveling between the LORAN station and the receiver; and
deriving a precise time reference from the received LORAN signals and the propagation time.

2. A method for deriving a precise time reference at a device when another precise time reference is not available at the device, comprising:
receiving LORAN signals at the device from a LORAN station;
determining the propagation time for the LORAN signals traveling between the LORAN station and the receiver; and
deriving a precise time reference at the device from the received LORAN signals and the propagation time when the another precise time reference is not available.

3. A method for deriving a precise time reference at a GNSS receiver when GNSS signals are not directly available at the GNSS receiver, comprising:
determining that GNSS signals are not directly available at the GNSS receiver;
receiving a plurality of LORAN signals from a LORAN station at the GNSS receiver;
receiving precise timing information from a reference station remote from the GNSS receiver, wherein the precise timing information includes time tags for each received signal from the LORAN station and the time tag includes a precise time reference for the time that the LORAN station sent the respective signal; and
deriving a precise time reference from the received LORAN signals and the time tags received from the reference station corresponding to the received LORAN signals.

4. A method according to claim 3, wherein multiple LORAN signals are received at the GNSS receiver from the LORAN station within a two-second period, and wherein the deriving includes integrating over the multiple received LORAN signals to improve the signal-to-noise ratio of the LORAN signals.

5. A method according to claim 3, wherein the time tags are adjusted for latency between the reference station and the receiving of the time tags.

6. A method for deriving a precise time reference when another precise time reference is not available, comprising:
receiving LORAN signals from a LORAN station;
receiving precise timing information from a reference station; and
deriving a precise time reference from the received LORAN signals received from LORAN station and the precise timing information received from the reference station when the another precise time reference is not available.

7. A method according to claim 6, wherein the precise timing information received from the reference station includes time tags for each received signal from the LORAN station and the time tag includes a precise time reference for the time that the LORAN station sent the respective signal.

8. A method according to claim 6, wherein the another precise time reference is GNSS time.

9. A method according to claim 6, wherein the another precise time reference is GPS time.

10. A method according to claim 6, further including:
correlating a new polluted signal to a previously known multi-path polluted LORAN correlation pattern to effect a sub-microsecond accuracy when dealing with heavily-attenuated LORAN signals in the scenario of a failover from GNSS.

11. A system for deriving a precise time reference with the aid of LORAN signals from a LORAN station, comprising:
a reference station located within range of the LORAN signals from the LORAN station, the reference station receiving GNSS signals and determining a precise time reference therefrom, the reference station also receiving LORAN signals from the LORAN station and determining the time of transmission of one or more of the LORAN signals from the LORAN station based at least in part on the distance between the LORAN station and the reference station; and
a receiver also located within range of the LORAN signals from the LORAN station, the receiver being in communication with the reference station to receive from the reference station the time of transmission of the one or more LORAN signals, wherein the receiver derives a precise time reference based at least in part on the received LORAN signals and their time of transmission from the LORAN station.

12. A system according to claim 11, wherein the derivation by the receiver is also based on the distance between the LORAN station and the receiver.

13. A method for providing timing information to a remote receiver, in part by utilizing LORAN signals from a LORAN station, comprising:
receiving GNSS signals at a reference station;
determining a precise time reference from the GNSS signals;
receiving LORAN signals from a LORAN station;
determining the time of transmission of one or more LORAN signals from the LORAN station based at least in part on the distance between the LORAN station and the reference station; and
communicating the time of transmission of the one or more LORAN signals to a remote receiver.
